(19) United States
(12) Patent Application Publication
(10) Pub. No.: US 2016/0073596 A1
(43) Pub. Date: Mar. 17, 2016

(54) Sub-Pavement Irrigation System

(71) Applicant: David Pals, Teutopolis, IL (US)

(72) Inventor: David Pals, Teutopolis, IL (US)

(21) Appl. No.: 14/488,056

(22) Filed: Sep. 16, 2014

(51) Int. Cl. A01G 25/06; A01C 23/04; A01G 25/16

(52) U.S. Cl. CPC A01G 25/06; A01G 25/16; A01C 23/04

(57) ABSTRACT

The present invention comprises an irrigation/aeration method and related device utilizing the optimal substrate air pocket properties of pea gravel and sub-pavement irrigation/aeration.

### FIELD OF THE INVENTION

The present invention is an irrigation/aeration method and related device utilizing the optimal substrate air pocket properties of pea gravel in tandem with sub-pavement irrigation/aeration.

### SUMMARY OF THE INVENTION

Specifically, the method of the present invention for irrigating/aerating beneath pavement comprises the steps of placing an irrigation/aeration pipe main supply line and distribution lines connected to the main supply line on an area to be paved; laying a layer of pea gravel over/around the irrigation/aeration pipe supply and distribution lines; paving over the layer of pea gravel over/around the irrigation/aeration pipe lines; connecting the irrigation/aeration pipe main supply line to a water/irrigation source and a compressed air source; and supplying air and water through the irrigation/aeration pipe main supply line to the layer of pea gravel encasing the irrigation/aeration pipe system. In additional embodiments of the invention, an additional first step of laying an initial layer of pea gravel on which the irrigation/aeration pipe main supply line is placed can be performed. Further, an additional step of providing separate air and water main supply lines to which the distribution lines are connected can be useful, and this could be further augmented by releasing air and/or water at pre-determined intervals by utilizing control device(s) known in the art, such as timers. These releases can occur at separate times, or the release of air and water can occur concurrently. A further desirable step in the method of the present invention can be the release of fertilizer either by air or water distribution.

The method of the present invention is preferably accomplished by utilizing the apparatus of the present invention which comprises a main supply line for air and/or water having opposing ends wherein at one end a water source connection is disposed along said line, and on an end opposing said one end a compressed air source connection is disposed; alternatively air and water could be introduced at the same end; distribution lines fluidly connected to said main supply line, wherein said distribution lines are end-capped and are perforated with orifices for distribution of water and/or air; and pea gravel surrounding said main supply line.

In alternate embodiments of the Invention, this apparatus can utilize separate main supply lines for air and water, or in another embodiment, the air source connection can be disposed between the water source connection and the distribution lines to allow the water itself to be aerated prior to distribution under the pavement. It is generally helpful for a control means for an air source to he disposed between the compressed air source connection and the distribution lines. Further, it is beneficial in some embodiments of the apparatus to have control means selected from the group including but not limited to manual valves, electronic valves, and simple connection to a source connections utilized to control flow and further to control time and duration of that flow by use of an electronic or manual timer set for pre-determined timed release.

Further embodiments of the apparatus additionally add at least one fertilizer source connection disposed between the water source connection and the distribution lines.

Generally, or specifically in areas where hydrostatic pressure is a concern, the apparatus can utilize weep holes at a height slightly below a bottom level of overlying pavement on at least one of any side walls of a raised paved area, or alternately or in conjunction with such weep holes, aeration plugs providing essentially a cylinder through which water under pressure from below the pavement can escape above the pavement can be disposed through the pavement,

in embodiments of the invention described herein, the apparatus will preferably utilized ½″ diameter pipes, but may utilize pipes between ¼″ and 1½″ diameter pipes or other diameter of pipes known in the art. Preferably, the depth of the pea gravel, particularly when utilizing ½″ diameter pipe would be 1½″ however, depths of approximately 1″ to 3″ can sill be considered optimal with thinner layers providing insufficient aeration and deeper layers requiring inefficient irrigation due to drainage without increasing water consumption to unneeded levels.

### BRIEF DESCRIPTIONS OF THE DRAWINGS

FIG. 1 depicts a schematic view of an embodiment of the invention displaying the interconnection of the main supply water/air line and distribution lines within a pea gravel layer underlying pavement and displaying an interplanting of a landscape planting;

FIG. 2 depicts a schematic view of an alternate embodiment of the invention displaying an alternate interconnection of distribution lines between separate main water and air supply lines;

FIG. 3 depicts a schematic view of another alternate embodiment of the invention displaying a single main supply wafer/air line with an alternate disposition of the compressed air titling in relation to the irrigation supply fitting: and

FIG. 4 depicts a portional cross-section of the invention showing the main line disposed within a pea gravel strata underlying pavement.

### BACKGROUND OF THE INVENTIONS

Irrigation is well-known in history, beginning with the digging of simple canals/ditches between crops. Since these early attempts to facilitate plant growth through artificial introduction of water to an otherwise too arid area, the field of irrigation has primarily focused on more efficient delivery of water to vegetation, and more recently, avoiding water loss due to evaporation.

These updates to the field have included multi-point water discharge and even the more modern sprinkler and soaker systems. Rapid urban growth in arid areas such as the American Southwest have spawned further innovations, including simple subsurface irrigation systems like the one described in U.S. Pat. No. 2,536,196 to MacLeod in 1951, describing a simple system of pipes buried beneath the surface which updated older irrigation systems simply drilled with holes in the pipe by providing an osmotic, elastically deformable plastic material disposed over the orifices drilled into the pipes.

While the field of art has significantly progressed with regard to irrigation in general, it has failed to progress sufficiently in dealing with obstacles to simple irrigation. One very typical problem in modem landscaping is providing suitable irrigation for landscape plants in a paved or semi-paved area. The problem presented is simple. People need or wish to have essentially flat areas, such as paved, concrete, brick or stone patios. People also wish to have elegantly landscaped areas surrounding these areas, and in some oases, intermingled with these areas in order to create their desired landscaped environments. Unfortunately, these two desires have been somewhat incompatible in their relationships.

Pavement and large stones/tiles/bricks generally prevent precipitation and air from reaching the area underneath them. In fact, contractors laying a base for these paving materials generally utilize materials such as sand and coarse gravel as underlayment to the pavement to ensure maximum drainage beneath the paving layer. However, these typical layers under the pavement provide an inhospitable environment for root growth for the desired landscaping plants such as trees or bushes that are most often desired in direct proximity to the paved areas. What generally results are primarily paved areas with unhealthy landscaping, despite often monumental, constant efforts to add water at the surface due to the maximal drainage beneath the paved areas. This often results in a “crusting” of the surface surrounding the plant(s), preventing maximum absorption of the water and thereby compounding the problem.

One way that contractors have sought to remedy the situation is to place aeration tile over the root area of the plant(s), surround the file with pea gravel, and then pave over the top. However, the passive air flow under the tile allows for very little air exchange within the gravel. Further, placement of aeration tile under the paved area generally requires raising the grade of the site 4″-6″ which is not suitable for all sites.

The instant invention sets forth a method and device for a dramatic improvement in this specific area of irrigation under paved areas that significantly improves the health of the surrounding or interplanted plant life. This is particularly true for plantings surrounded by paved areas, for instance, the normally pathetic tree plantings surrounded by sidewalks in suburban areas can become lush, normal looking vegetation with the utilization of the present device and method.

### DESCRIPTION OF A PREFERRED EMBODIMENT

The present invention comprises a device and method for sub-pavement irrigation and aeration. Specifically, the method comprises placing an irrigation/aeration pipe main supply line and distribution lines connected to the main supply line on an area to he paved; pouring pea gravel over/around the laid PVC pipe; connecting a main wafer line and compressed air line; disposing the desired paving over the irrigated area; connecting the irrigation/aeration pipe main supply line to a water/irrigation source and a compressed air source; and supplying air and water through the irrigation/aeration pipe main supply line to the layer of pea gravel encasing the irrigation/aeration pipe system.

Alternately, an additional first step of laying an initial layer of pea gravel on which the irrigation/aeration pipe main supply line is placed can be made, essentially encasing the irrigation/aeration main supply line and distribution lines system within a layer of pea gravel preferably of essentially equal depth above and below the system.

Further, additional steps of providing separate air and water main supply lines to which the distribution lines are connected and/or the step of supplying air and wafer through the irrigation/aeration pipe main supply line the air and water, released at pre-determined intervals by control device(s), can be utilized. The step of supplying air and/or water can occur at separate, distinct times instead of concurrently if desired. Utilizing at least one optional fertilizer inlet, fertilizer is additionally supplied, dispersed either by the water.

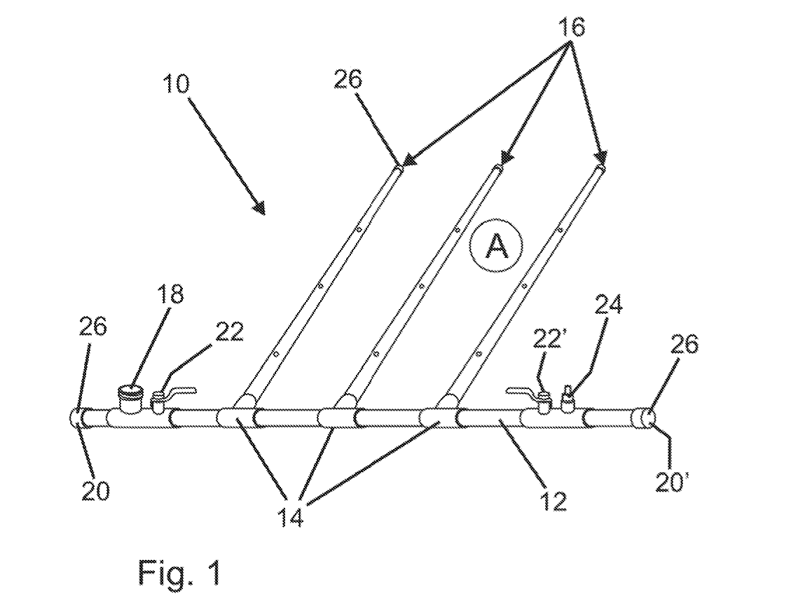

The preferred irrigation/aeration apparatus 10 of the present invention, as depicted in FIG. 1 for use under an essentially rectangular configuration paved area, comprises a main water supply line 12 having multiple junctures 14 radiating secondary delivery lines 16. Main supply line 12 will preferably additionally comprise a fitting 18 for connection to a water supply. In a preferred cost critical embodiment, for instance, an attachment fitting suitable for connection to a garden hose may be utilized, here disposed at an end 20 of main supply line 12. Electronic or manual or timed release control devices 22,22′ such as a simple quarter turn valve, for the release of irrigation water or air may be in congress with main supply line 12 at points at or after the water or air entry points on main line 12. Compressed air fitting 24, is disposed at opposing end 20′ of main supply line 12. In this embodiment, utilizing one supply line 12 for both water and air, ends 26 of delivery/distribution lines 16 and main line 12 can have caps stopping the ends of the line to maintain proper pressure and cease flow.

In all three figures, FIG. 1-3, but particularly depicted in FIG. 4, in the essentially rectangular area depicted, pea gravel 30 would be laid under and over apparatus 10 in essential equal amounts. Pavement or paving stones would be laid over the overlaying layer of pea graves. In the FIGS. 1-3, an interplanting within the paved area of a tree is depicted as circle A.

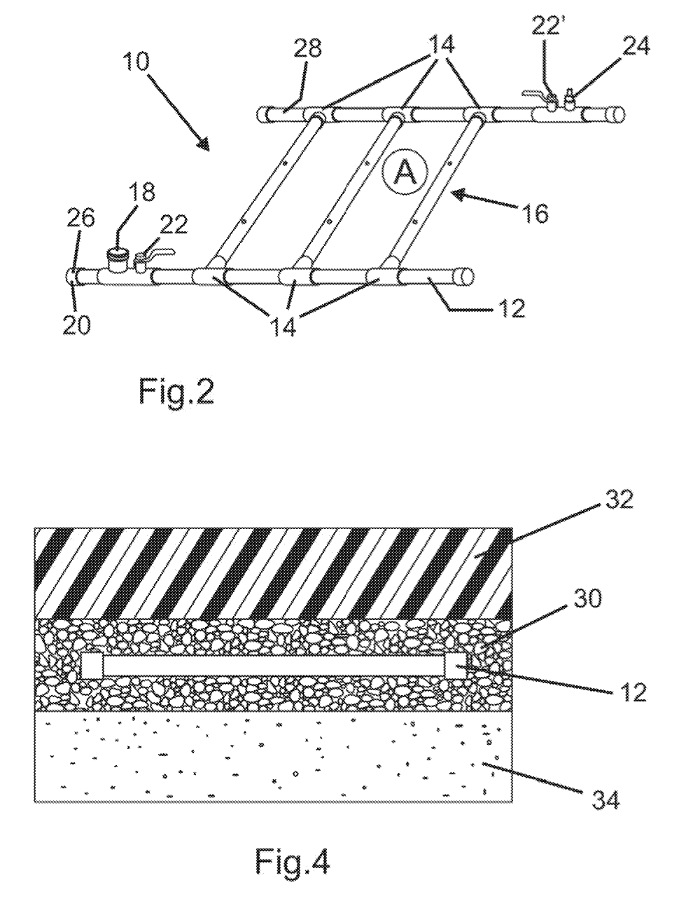

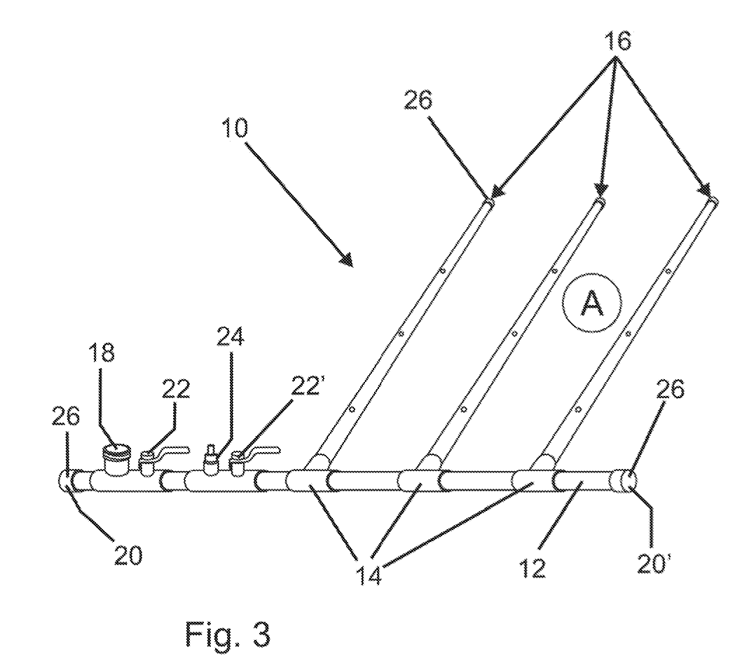

In alternate embodiments, fitting 18 can comprise a permanent or semi-permanent attachment to an existing, dedicated irrigation water supply line, and fitting 24 can comprise a permanent or semi-permanent attachment to an existing, dedicated air compression mechanism or can be open for attachment to a portable device. Additionally, alternate embodiments may comprise alternate supply lines for addition of compressed air and water, for instance, as depicted in FIG. 2, a separate air supply line 28 could be connected in a reciprocal matter to the opposing ends of the distribution lines creating an overall “H” pattern to the apparatus. In a further alternate embodiment depicted in FIG. 3, compressed air fitting 24 can be disposed between control device 22 and delivery lines 16, allowing for aeration of water flow itself. In such an embodiment, end 20′ would he capped 26, and a control device 22′ correlating with the distribution of air would be inserted between fitting 24 and delivery lines 16.

FIG. 4 depicts strata of a paved surface 32 overlying pea gravel layer 30 in which main line 12 is disposed above soil 34.

Preferably, the delivery line pipes will be disposed at 5′-6′ spaced intervals interconnected with the supply line(s). This may be varied depending on the needs of the particular planting, diameter of the supply and delivery lines and orifice configuration in the delivery lines. The delivery line pipe is pre-drilled/perforated with holes, slots, or other suitable configuration of orifices of approximately ⅛″ diameter or other appropriate size known in the art, and at intervals of approximately 12″ along the pipe or at other intervals and configurations known in the art, particularly when other orifice diameters are utilized. For instance, as disclosed in U.S. Pat. No. 4,293,237 to Robey et al., a dual orifice orientation comprising slots on a lower side of the pipe and holes on an upper side of the pipe would allow for efficient irrigation and separate aeration of the intended area. However, unlike Robey et al., the aeration of the present device need not be separate from an irrigation function. In one embodiment of the present apparatus, irrigation and aeration can be utilized simultaneously by bubbling air through the water and therefore aerating the target area during irrigation.

It is preferred that the pipe be comprised of PVC or other appropriate material known in the art. Further, it is preferred that the pipe have an approximate diameter of ½″ OD for a pea gravel layer of 1½″, however, should an alternate diameter pipe be utilized for, in particular an increased volume of water; then if is preferred that the pea gravel layer be increased to approximately three (3) to six (6) times the amount of the diameter of the pipe. In further embodiments, additional inlets may he provided on the main supply lines for addition of fertilizer to be introduced to the area. Fertilizers that are distributed via wafer are known and either source could be used to introduce fertilizer info the area.

Further, it is understood that the wafer and air sources herein can be utilized at the same time or separately. Further, in embodiments where the air source connection is disposed between the wafer source connection and the distribution lines, air can be forced into the water in proximity to its source which can be useful for concurrent irrigation/aeration.

In methods wherein the pavement overlying the system is essentially level with the surrounding ground, the pea gravel layer will, by osmosis, distribute extra moisture to the surrounding soil, preventing an unacceptable level of hydrostatic pressure under the pavement which could, over time, damage the pavement. However, should this be a concern in, for instance, extremely wet areas where sub-pavement aeration would be especially beneficial, aerating plugs, opening the paved area to upward relief pressure can be placed through the pavement. In methods wherein the pavement overlying the system is raised above the surrounding ground and supported by side walls, weep holes can be provided in the side waits at a level below a bottom level of the pavement, essentially at an upper level of the pea gravel layer, allowing excess moisture to drain or to be forced out by aeration.

While sub-surface irrigation and aeration devices are known in the art, the instant apparatus and method are novel with the utilization of pea gravel or substrate of similar diameter, approximately ⅜″ to ⅝″. However, slight variations on the size, including inclusion of some material intermixed with a slightly differing diameter may be utilized if the overall composition of the layer is approximately ⅜ to ⅝ inch diameter. Pea gravel is the ideal material for this application as it allows for an approximately 25% volume pore space between individual stones Therefore, for example, a 400 ft² patio would hold approximately 12.5 ft³ of air within the pea gravel air pockets. Utilizing the aeration feature of the described apparatus, preferably daily, would greatly increase the available and necessary oxygen for plant roots. This could be easily accomplished, for instance, by utilizing a version of the apparatus having a 70 l/min, air pump for approximately five (5) minutes.

Currently in the art, several strata are provided before laying pavement including coarse gravel and sand layers, typically at least 4″-6″. This is done primarily for the good of the overlying pavement, not any surrounding or intermingled plantings. For situations involving paving an area near or around a tree or trees or other large landscaping plants, the instant method and apparatus are highly preferable for providing optimal growth environments for these landscaping plants while balancing the need for paved surfaces in proximity with them. Surprisingly, the pea gravel provides a remarkably superior substrate over sand and larger diameter materials. It is believed that this is because the pea gravel provides the ideal air “pocketing” volume between stones of its diameter in order to allow both air and water to reach the roots of landscape plants without allowing the water to drain too slowly or too quickly. Further, the instant method and device utilize an optimal layer between approximately 1″-3″ of pea gravel, and most preferably 1½″ of pea gravel without other layers when utilizing a ½″ OD pipe, significantly reducing costs.

I claim:

1. A method for irrigating/aerating beneath pavement comprising the steps of:
placing an irrigation/aeration pipe main supply line and distribution lines connected to the main supply line on an area to be paved;
laying a layer of pea gravel over/around the irrigation/aeration pipe supply and distribution lines;
paving over the layer of pea gravel over/around the irrigation/aeration pipe lines;
connecting the irrigation/aeration pipe main supply line to a wafer/irrigation source and a compressed air source; and
supplying air and water through the irrigation/aeration pipe main supply line to the layer of pea gravel encasing the irrigation/aeration pipe system.

2. The method of claim 1 including the additional first step of laying an initial layer of pea gravel on which the irrigation/aeration pipe main supply line is placed.

3. The method of claim 1 including the additional step of providing separate air and water main supply lines to which the distribution lines are connected.

4. The method of claim 1 wherein in the step of supplying air and water through the irrigation/aeration pipe main supply line, the air and wafer are released at pro-determined intervals by control device(s).

5. The method of claim 1 wherein in the step of supplying air and water, the supply of air or water can occur at separate times.

6. The method of claim 5 wherein in the step of supplying air and water, fertilizer is additionally supplied with water.

7. An apparatus for irrigation/aeration beneath pavement comprising:
a main supply line for air and/or water having opposing ends wherein at one end a water source connection is disposed along said line, and on an end opposing said one end a compressed air source connection is disposed;
distribution lines fluidly connected to said main supply line, wherein said distribution lines are end-capped and are perforated with orifices for distribution of water and/or air; and
pea gravel surrounding said main supply line.

8. The apparatus of claim 7 additionally comprising separate main supply lines for air and water.

9. The apparatus of claim 7 additionally comprising control means disposed between said water or air source and said distribution lines.

10. The apparatus of claim 9 wherein said compressed air source connection is disposed between said air source and said distribution lines.

11. The apparatus of claim 10 wherein said control means for said air source is disposed between said compressed air source connection and said distribution lines.

12. The apparatus of claim 9 wherein said control means are selected from the group consisting of manual valves, electronic valves, and simple connection to said source connections.

13. The apparatus of claim 9 wherein said control means are controlled by an electronic or manual timer set for pre-determined timed release.

14. The apparatus of claim 7 comprising at least one fertilizer source connection disposed between the water source connection and the distribution lines.

15. The apparatus of claim 7 comprising at least one fertilizer source connection disposed between the air source connection and the distribution lines.

16. The apparatus of claim 7 additionally comprising aeration/weep holes at a height slightly below a bottom level of overlying pavement on at least one of any side walls of a raised paved area.

17. The apparatus of claim 7 additionally comprising aeration/weep holes plugs disposed through the pavement.

18. The apparatus of claim 7 wherein said supply and distribution lines comprise ¼″ to 1½″ diameter pipes.

19. The apparatus of claim 18 wherein said supply and distribution lines comprise ½″ diameter pipes.

20. The apparatus of claim 7 wherein said pea gravel layer is between approximately 1″ and 3″ in depth.
